(19) United States
(12) Patent Application Publication
(10) Pub. No.: US 2010/0250335 A1
(43) Pub. Date: Sep. 30, 2010

(54) SYSTEM AND METHOD USING TEXT FEATURES FOR CLICK PREDICTION OF SPONSORED SEARCH ADVERTISEMENTS

(75) Inventors: Ozgur Cetin, New York, NY (US); Rukmini Lyer, Los Altos, CA (US); Benyah Shaparenko, Myerstown, PA (US)

Correspondence Address: Mauriel Kapouytian & Treffert LLP, 151 1st Avenue, #23, New York, NY, 10003, US

(73) Assignee: Yahoo! Inc, Sunnyvale, CA (US)

(21) Appl. No.: 12/415,879

(22) Filed: Mar. 31, 2009

(51) Int. Cl. G06Q 30/00; G06F 17/30; G06N 5/02; G06Q 10/00

(52) U.S. Cl. 705/10; 706/52; 707/E17.108; 705/400; 705/14.45; 705/14.52; 705/14.54

(57) ABSTRACT

An improved system and method using text features for click prediction of sponsored search advertising is provided. A maximum entropy click prediction model that predicts the click probability of query-advertisement pairs may be generated from click feedback features and word pair features of a query and an advertisement. The maximum entropy click prediction model may be used to obtain click probabilities for query-advertisement pairs to determine and serve a ranked list of advertisements for display with query results in an online keyword search auction. A search query may be received and word features from the search query may be input into the maximum entropy click prediction model to obtain click probabilities for query-advertisement pairs. A list of advertisements may be ranked using click probabilities for query-advertisement pairs, the list of ranked advertisements may be priced in an online search keyword auction and served for display with search query results.

### FIELD OF THE INVENTION

The invention relates generally to computer systems, and more particularly to an improved system and method using text features for click prediction of sponsored search advertisements.

### BACKGROUND OF THE INVENTION

Advertising drives much of the revenue on the Internet today. Online system operators derive a large portion of their revenue from sponsored search advertisements that appear on the search results page with search results from a search engine. When the user inputs a search query, the online system not only returns a set of relevant search results from a search engine, but also returns a set of advertisements that are potentially interesting to the user and that could provide the online system with revenue. Each advertiser can bid on a set of keywords, and online keyword auctions allocate a limited number of advertising slots to the highest ranking advertisements. The online system operators typically use a pay-per-click model in which the online system operator receives a certain amount of revenue from the advertiser each time the user clicks on an advertisement. The advertiser then hopes to convert the user's click through to the advertiser's site into revenue, while the search engine tries to maximize its revenue by displaying advertisements that the users find interesting or useful, so that they will be likely to click on the advertisements. To maximize revenue, the search engine typically ranks advertisements by their expected revenue, which may be calculated, for example in a second price auction, by multiplying the advertiser's bid and the probability the advertisement will be clicked by a user if displayed for that query. The limited number of advertising slots may then be allocated to the highest ranking advertisements. Thus, predicting the click probability as accurately as possible is a central focus in sponsored search advertising.

In practice, the click probability may be relatively easy to determine for advertisements that have been previously displayed in online keyword auctions, especially for those advertisements that have been displayed many times and consequently have substantial click history which may be collected. However, where there may be minimal click history for advertisements, the click probability may be difficult to accurately estimate. Moreover, for new advertisements, the click probability may be unknown to the online system conducting the keyword auction. Accordingly, an online system conducting a keyword auction must somehow estimate the click probability for advertisements with minimal or no click history. It is a challenge to accurately estimate the click probability for such advertisements that would allow a search engine to display the most relevant advertisements and to price them correctly in an online auction. Given the large scale of search engine traffic, small errors in finding this probability can result in much lost revenue and in an adverse user experience.

What is needed is a system and method for predicting the click probability as accurately as possible for sponsored search advertising. Such a system and method should improve on the click feedback systems used in current search engines and predict the click probability as accurately as possible where there may be minimal or no click history for advertisements and queries.

### SUMMARY OF THE INVENTION

Briefly, the present invention may provide a system and method using text features for click prediction of sponsored search advertising. In various embodiments, a web browser executing on a client device may be operably coupled to a server for receiving a list of advertisements from the server for display by the web browser in a search results page. The server may include an operably coupled advertisement serving engine that selects the list of advertisements using text-based features extracted from a query and a set of advertisements and may serve the list of advertisements to the web browser executing on the client for display with the search results of a search query. The advertisement serving engine may include a maximum entropy click prediction model generator that may construct a maximum entropy click prediction model for click feedback features and word pair features taken from a query and a set of advertisements to predict click probabilities of query-advertisement pairs. The advertisement serving engine may also include an advertisement selection engine for using the maximum entropy click prediction model to rank and output a list of the advertisements for a search query.

To generate a maximum entropy click prediction model that predicts the click probability of query-advertisement pairs, click feedback features and word pair features from a query and an advertisement may be received. In an embodiment, query term absence features may also be received that indicate there are not any word pair features for a query-advertisement pair. Once the word pair features, any query term absence features, click feedback features and any other features related to the query and/or advertisement, may be received, a maximum entropy click prediction model that predicts the click probability of query-advertisement pairs may be generated from the features. The maximum entropy click prediction model may then be used in an embodiment to obtain click probabilities for query-advertisement pairs to determine and serve a ranked list of advertisements for display with query results in an online keyword search auction. A search query may be received and word features from the search query may be input into the maximum entropy click prediction model to obtain click probabilities for query-advertisement pairs. A list of advertisements may then be ranked by an expected value representing the product of an advertiser bid and a click probability for the query-advertisement pair. Web page placements may be allocated for the ranked list of advertisements, and the list of ranked advertisements may be served for display with query results. The probability of click provided by the maximum entropy model may be used for pricing the advertisements in any online keyword search auction using expected revenue.

Advantageously, the present invention may accurately predict the click probability where there may be minimal or no click history for advertisements. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for using text features for click prediction of sponsored search advertising, in accordance with an aspect of the present invention;

FIG. 3 is a flowchart generally representing the steps undertaken in one embodiment for using text features for click prediction of sponsored search advertising, in accordance with an aspect of the present invention;

FIG. 4 is a flowchart generally representing the steps undertaken in one embodiment for generating a maximum entropy click prediction model that predicts the click probability of query-advertisement pairs using text features for click prediction of sponsored search advertising, in accordance with an aspect of the present invention; and

FIG. 5 is a flowchart generally representing the steps undertaken in one embodiment on a server to obtain click probabilities for query-advertisement pairs using the maximum entropy click prediction model to determine and serve a ranked list of advertisements for display with query results, in accordance with an aspect of the present invention.

### DETAILED DESCRIPTION

### Exemplary Operating Environment

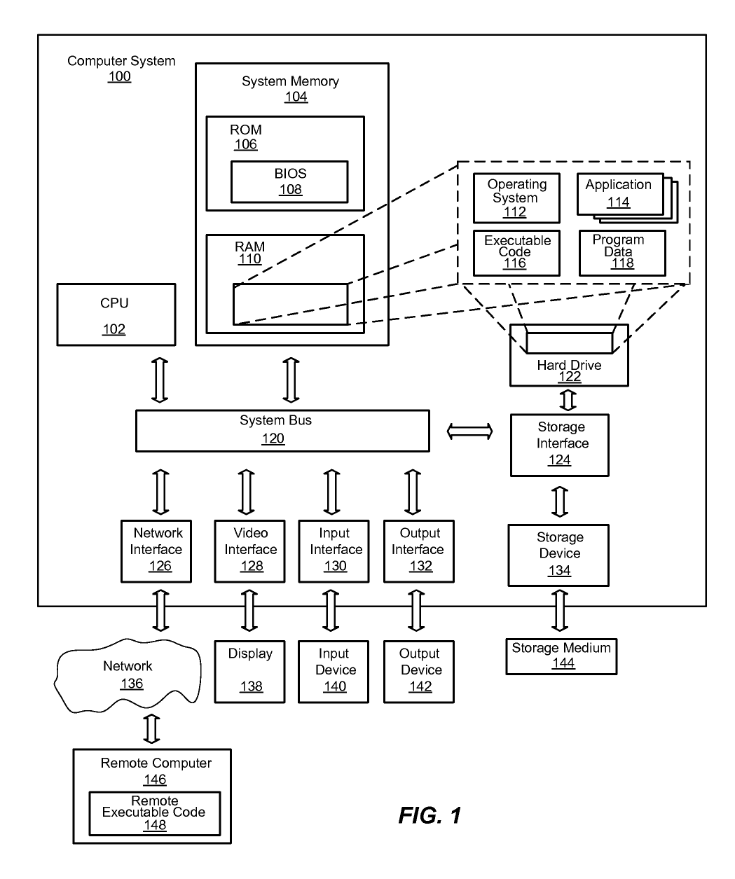

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Using Text Features for Click Prediction of Sponsored Search Advertising

The present invention is generally directed towards a system and method using text features for click prediction of sponsored search advertising. To generate a maximum entropy click prediction model that predicts the click probability of query-advertisement pairs, click feedback features and word pair features from a query and an advertisement may be received. In an embodiment, query term absence features may also be received that indicate there is a query term without any associated term from an advertisement, and therefore there are not any word pair features for a query-advertisement pair. Once the word pair features, any query term absence features, and click feedback features may be received, a maximum entropy click prediction model that predicts the click probability of query-advertisement pairs may be generated from the features. The maximum entropy click prediction model may then be used in an embodiment to obtain click probabilities for query-advertisement pairs to determine, price and serve a ranked list of advertisements for display with query results in an online keyword search auction.

As will be seen, a search query may be received and word features from the search query may be input into the maximum entropy click prediction model to obtain click probabilities for query-advertisement pairs. A list of advertisements may then be ranked using click probabilities for query-advertisement pairs, and the list of ranked advertisements may be served for display with search query results. As will be understood, the various block diagrams, flow charts and scenarios described herein are only examples, and there are many other scenarios to which the present invention will apply.

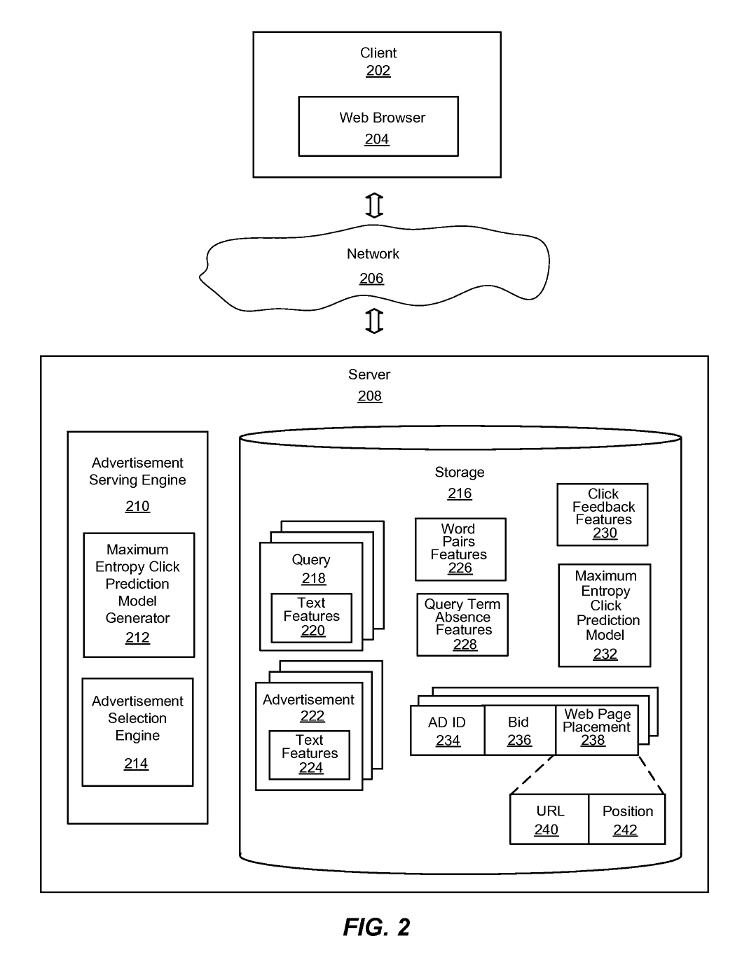

Turning to FIG. 2 of the drawings, there is shown a block diagram generally representing an exemplary architecture of system components for using text features for click prediction of sponsored search advertising. Those skilled in the art will appreciate that the functionality implemented within the blocks illustrated in the diagram may be implemented as separate components or the functionality of several or all of the blocks may be implemented within a single component. For example, the functionality for the maximum entropy click prediction model generator 212 may be included in the same component as the advertising selection engine 214. Or the functionality of the maximum entropy click prediction model generator 212 may be implemented as a separate component from the advertising selection engine 214 as shown. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query, functionality for sending the query request to a search engine to obtain a list of search results, and functionality for receiving a list of advertisements from a server for display by the web browser, for instance, in a search results page on the client device. In general, the web browser 204 may be any type of interpreted or executable software code such as a kernel component, an application program, a script, a linked library, an object with methods, and so forth. The web browser 204 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The server 208 may be any type of computer system or computing device such as computer system 100 of FIG. 1. In general, the server 208 may provide services for sending a list of advertisements to the web browser 204 executing on the client 202 for display with the search results of query processing. In particular, the server 208 may include an advertisement serving engine 210 that may include functionality to select the list of advertisements using text-based features extracted from a query and a set of advertisements and may serve the list of advertisements to the web browser 204 executing on the client 202 for display with the search results of query processing. The advertisement serving engine 210 may include a maximum entropy click prediction model generator 212 that may construct a maximum entropy click prediction model 232 for click feedback features 230 and word pair features 226 taken from a query 218 and a set of advertisements 222 to predict click probabilities of query-advertisement pairs. The advertisement serving engine 210 may also include an advertisement selection engine 214 for using the maximum entropy click prediction model to rank and output a list of the advertisements for a search query. Each of these components may also be any type of executable software code such as a kernel component, an application program, a linked library, an object with methods, or other type of executable software code. These components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The server 208 may be operably coupled to storage 216 that may store a set of queries 218 received with text features 220 and a set of advertisements 222 with text features 224. In an embodiment, the set of queries 218 may be extracted from historical log files and each query may have text features 220 such as keywords, keyword frequencies and other syntactic features. As used herein, a text feature means an attribute of a sequence of characters including syntactic or semantic properties, words, term frequency, term position and so forth. The text features 224 of the advertisements 222 may similarly include keywords, keyword frequencies and other syntactic features. The storage 216 may also store word pair features 226 that represent a feature from a query and a feature from an advertisement, query term absence features 228 that represent a query term without any associated term from an advertisement, and click feedback features 230 indicating the click history of an advertisement impression for a query-advertisement pair. The storage 216 may also store a maximum entropy click prediction model 232 constructed using the word pair features 226, the query term absence features 228 and the click feedback features 230 to output a ranked list of advertisements. In an embodiment, an advertisement 222 may be displayed according to a web page placement 236. An advertisement 222 may be associated with an advertisement ID 234 and may be stored in storage 216 with the bid 236 of an advertiser. The advertisement ID 234 associated with an advertisement 222 may be allocated to a web page placement 238 that may include a Uniform Resource Locator (URL) 240 for a web page and a position 242 for displaying an advertisement on the web page. As used herein, a web page placement may mean a location on a web page designated for placing an advertisement for display. In various embodiments, a web page may be any information that may be addressable by a URL, including a document, an image, audio, and so forth.

Online keyword search auction may use the present invention to provide a list of advertisements to be displayed on the search results page of a client browser in online advertising. When a user may submit a search query request, the present invention may be used to predict the probability of a click on an advertisement for serving advertisements. In various embodiments, the list of advertisements may appear in the sponsored search results area of the search results page. In an embodiment of a second price auction, for example, the list of advertisements may be selected from winning bidders in the auction for one or more keywords in the search query and ranked by the expected revenue that may be calculated as the product of an advertiser's bid and the probability of a click on an advertisement predicted by the maximum entropy click prediction model. For any online keyword search auction, the probability of a click on an advertisement may be predicted by the present invention for serving advertisements in online advertising.

For sponsored search advertising, features may be drawn from both the click history and static sources such as the query and advertiser texts. The click feedback features may draw information from the past click history to infer the quality of advertisements for a query. A number of different features can be extracted from click history to derive rank-normalized click-through rate features. As used herein, a click feedback feature means an attribute or value derived from the click history of an advertisement impression for a query-advertisement pair, including user responses to the advertisement impression, web page placement, timestamp, click-through rate, and so forth. In general, the text features of a query and of an advertisement are advantageously useful without sizable click-feedback history for sponsored search click prediction.

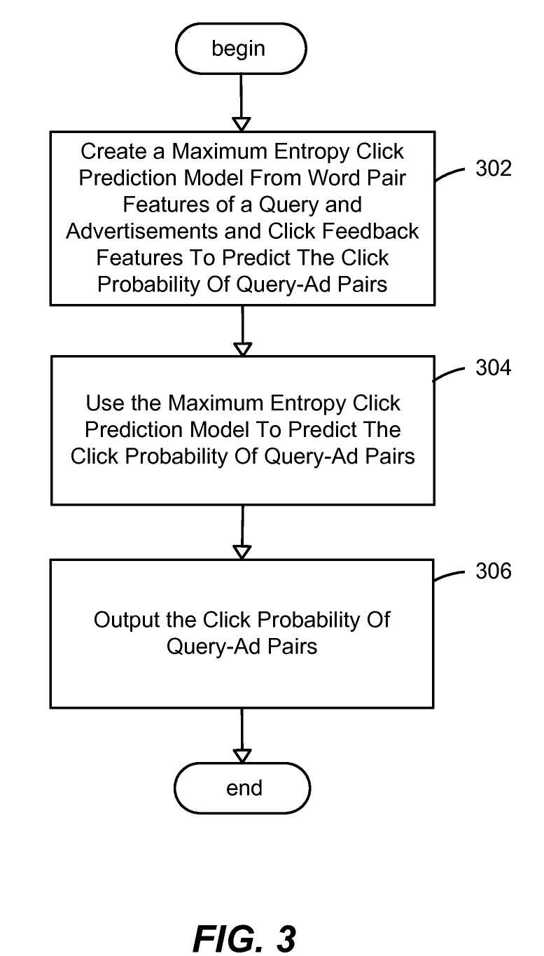

FIG. 3 presents a flowchart generally representing the steps undertaken in one embodiment for using text features for click prediction of sponsored search advertising. At step 302, a maximum entropy click prediction model that predicts the click probability of query-advertisement pairs may be generated from word pair features of a query and advertisements and click feedback features. Sponsored search advertisements may provide several sources of advertiser text available for generating text features, including an advertisement title, an advertisement abstract, and keywords bid upon by the advertiser. To learn features that will capture useful syntactic and/or semantic features for ranking sponsored search advertisements, a set of word pair features may be constructed that may be used to predict a user's response to a query and an advertisement. As used herein, a word pair feature means a pair of text features representing a text feature from a search query and a text feature from one of the text sources of an advertisement. The word pair features may take the form of a pair of words representing a word from the query and a word from one of the text sources of an advertisement. In an embodiment, a value of 1 or 0 may be assigned that signifies whether the term pair is present or absent in the query and advertisement pair. For example, if the user's query may include the word “mp3” and an advertisement title includes the term “ipod”, then one possible text feature for the maximum entropy model will be the word pair (mp3, ipod). The click feedback features may draw information from the past click history to infer the quality of advertisements for a query. A number of different features can be extracted from click history to derive rank-normalized click-through rate features. A correlation between the click feedback features and the word pair features may be determined. For example, a dictionary of about 100,000 terms of the words that occur in the advertisements that have been clicked at least 50 times in the training data may be compiled. Given a list of advertisements, a, displayed to a user for a query, q, and the user's response, click (1) or not-a-click (0), denoted by c, a maximum entropy click prediction model may be constructed to predict p(c|q,a), the click probability of an advertisement for a query by a user.

Once the maximum entropy click prediction model may be constructed, the maximum entropy click prediction model may be used at step 304 to predict the click probability of query-advertisement pairs. And at step 306, the click probability of query-advertisement pairs may be output. In various embodiments, the output may be the click probability of one or more query-advertisement pairs from a ranked list of query-advertisement pairs in order by predicted click probability.

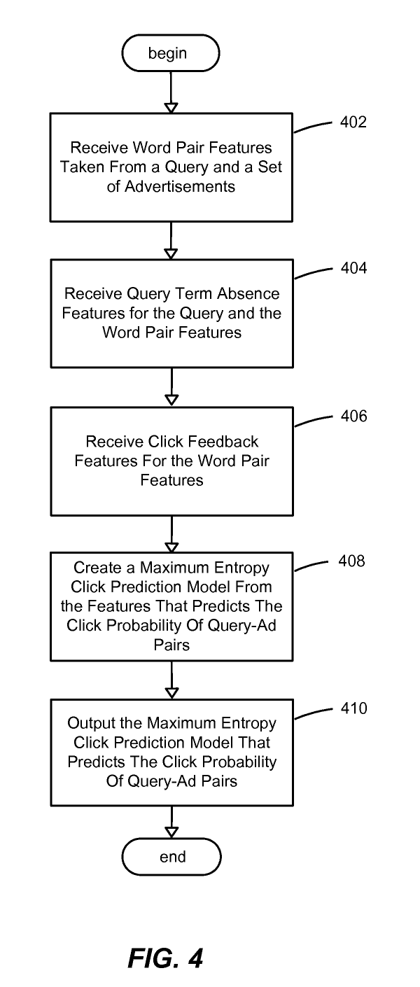

FIG. 4 presents a flowchart generally representing the steps undertaken in one embodiment for generating a maximum entropy click prediction model that predicts the click probability of query-advertisement pairs using text features for click prediction of sponsored search advertising. At step 402, word pair features from a query and an advertisement may be received. In practice, word pair features may be received for sets of a query and the associated advertisements displayed with each query. In various embodiments, diagonal pairs or basic syntactic matches are used to generate word pair features from a word of a query and a word of an advertisement. In various other embodiments, off-diagonal pairs or pairs of different words in the query and advertiser texts are used to generate word pair features from a word of a query and a word of an advertisement. Because there is potentially a very large of number of such off-diagonal pairs, feature selection of off-diagonal pairs may be performed by correlating the off-diagonal pairs with a binary click indicator and a set of example query-advertisement pairs that were collected from search engine logs using the following equation:

$$ρ ≡ \frac{{\sum }_{i} ( {c}_{i} - \overline{c} ) ( {s}_{i} - \overline{s} )}{\sqrt{{\sum }_{i} {( {c}_{i} - \overline{c} )}^{2} {\sum }_{i} {( {s}_{i} - \overline{s} )}^{2}}} ,$$

where cᵢ is the binary click indicator, and sᵢ is the feature value associated with the i-th example (1 for clicked examples and 0 for the remaining ones). The cross-correlation may be a simple, effective metric to eliminate most of the irrelevant off-diagonal pairs.

At step 404, query term absence features may be received for the query and the word pair features. A query term absence feature means herein an indicator that a query term does not have any associated word for the advertisement. Consequently, a query term absence feature indicates there are not any word pair features for a query-advertisement pair. The query term absence features may provide a form of normalization for the total number of word pair features that are found for a query-advertisement pair. In addition to being derived from sets of a query and word pair features, query term absence features may also be derived from sets of a query and the associated advertisements displayed with each query. And at step 406, click feedback features may be received for the word pair features. In an embodiment, the click-feedback features may represent rank-normalized click-through rate features.

Once the word pair features, any query term absence features, and click feedback features may be received, a maximum entropy click prediction model that predicts the click probability of query-advertisement pairs may be generated from the features at step 408. In an embodiment, the following equation may be used to generate the maximum entropy click prediction model that predicts the click probability of query-advertisement pairs from the features:

$$p ( c \vert q , a ) = \frac{1}{1 + exp ( \sum {w}_{i} {f}_{i} ( q , a ) )} ,$$

where fᵢ(q,a) denotes the i-th feature derived for that query-advertisement pair, wᵢ is the corresponding weight, and N is the total number of features.

Given a set of logged query-advertisement pairs and associated user responses, {cₜ,qₜ,aₜ}ₜ₋₁^{T}, the estimation of weights wᵢ can be solved by the following equation to find a maximum-a-posterior probability: where

$${w}^{*} = arg max {\sum }_{t = 1}^{T} log p ( {c}_{t} \vert {q}_{t} , {a}_{t} ) + log p ( w ) ,$$

the first term is the likelihood of data, and the second term is the prior over weights which may be Gaussian. The maximum-a-posterior probability problem is well-studied, and there are a number of well-known fast, scalable algorithms to solve it. See, for example, T. Minka, A Comparison of Numerical Optimizers for Logistic Regression, Microsoft Technical Report, 2003 (Revised 2007). In an embodiment, a nonlinear conjugate-gradient algorithm that can handle vectors with millions of dimensions may be used with the word-pair features.

And at step 410, the maximum entropy click prediction model that predicts the click probability of query-advertisement pairs may be output. For instance, the maximum entropy click prediction model may be stored in computer-readable storage. After the maximum entropy click prediction model may be output, processing may be finished for generating a maximum entropy click prediction model that predicts the click probability of query-advertisement pairs using text features for click prediction of sponsored search advertising. The maximum entropy click prediction model may be used, for instance, to obtain click probabilities for query-advertisement pairs to determine and serve a ranked list of advertisements for display with query results in an online keyword search auction.

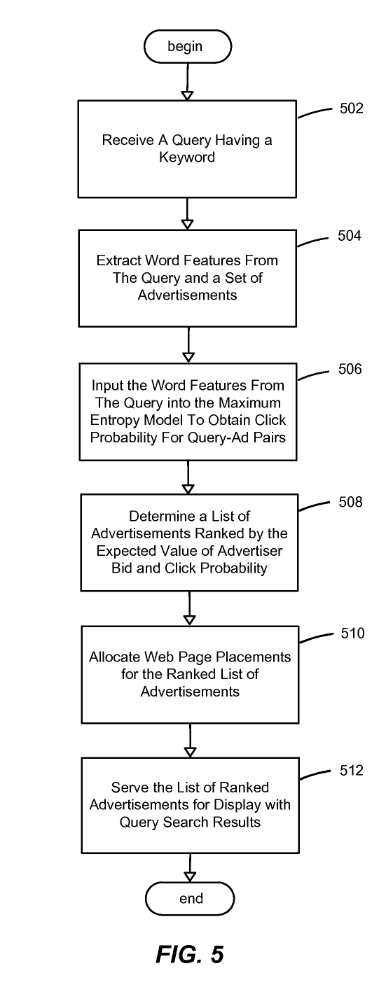

FIG. 5 presents a flowchart generally representing the steps undertaken in one embodiment on a server to obtain click probabilities for query-advertisement pairs using the maximum entropy click prediction model to determine and serve a ranked list of advertisements for display with query results. In an embodiment, an advertisement selection engine may apply the maximum entropy click prediction model to rank and output a list of the advertisements for a search query for display with query results. At step 502, a query having a keyword may be received. For instance, an advertisement serving engine may receive a query having one or more keywords. At step 504, word features may be extracted from the query and a set of advertisements. In various embodiments, the word features may represent keywords from the query. Each word feature may represent a text feature from the search query, including a syntactic or semantic property, a word or phrase, term frequency, term position and so forth.

At step 506, the word features from the query may be input into the maximum entropy click prediction model to obtain click probabilities for query-advertisement pairs. A list of advertisements ranked by an expected value representing the product of an advertiser bid and a click probability may be determined at step 508. At step 510, web page placements may be allocated for the list of advertisements ranked by the expected value representing the product of an advertiser bid and a click probability. And the list of ranked advertisements may be served for display with query results at step 512. In an embodiment, the list of advertisements ranked by the expected value may be served to a web browser executing on a client device for display with query results.

Thus the present invention may more accurately predict the click probability of advertisements in online keyword search auctions using text-based features and click feedback features. Advantageously, the present invention may more accurately predict the click probability where there may be minimal or no click history for advertisements. Importantly, even slight increases in accuracy in predicting the click probability of advertisements can result in substantial increased revenue and in a better user experience, given the large scale of search engine traffic. Accordingly, more accurate estimates of the click probability for such advertisements allow a search engine to display the most relevant advertisements and to price them correctly in an online keyword auction. Those skilled in the art will appreciate that there may be other implementations of the click prediction model. In addition to the maximum entropy click prediction model, other click prediction models using text-based features and click feedback features may be used to estimate p(c|q,a), the click probability of an advertisement for a query by a user, including binary classification models that predict the click probability of query-advertisement pairs from click feedback features and word pair features of a query and an advertisement.

As can be seen from the foregoing detailed description, the present invention provides an improved system and method using text features for click prediction of sponsored search advertising. A maximum entropy click prediction model that predicts the click probability of query-advertisement pairs may be generated from click feedback features and word pair features of a query and an advertisement. The maximum entropy click prediction model may then be used to obtain click probabilities for query-advertisement pairs to determine and serve a ranked list of advertisements for display with query results in an online keyword search auction. A search query may be received and word features from the search query may be input into the maximum entropy click prediction model to obtain click probabilities for query-advertisement pairs. A list of advertisements may then be ranked using click probabilities for query-advertisement pairs, and the list of ranked advertisements may be served for display with search query results. For any online keyword search auction, the probability of a click on an advertisement may be predicted by the present invention for serving advertisements in online advertising. As a result, the system and method provide significant advantages and benefits needed in contemporary computing and in online advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for click prediction of online advertising, comprising:
a maximum entropy click prediction model generator that generates from a plurality of click feedback features and a plurality of word pair features, taken from at least one query and at least one advertisement, a maximum entropy click prediction model that predicts a click probability of a plurality of query-advertisement pairs; and
a storage, operably coupled to the maximum entropy click prediction model generator, that stores the maximum entropy click prediction model and the plurality of click feedback features and the plurality of word pair features.

2. The system of claim 1 further comprising an advertisement selection engine, operably coupled to the storage, that uses the maximum entropy click prediction model to rank and output a list of the at least one advertisement for the at least one query.

3. The system of claim 2 further comprising an advertisement serving engine, operably coupled to the advertisement selection engine, that serves the list of the at least one advertisement for the at least one query to a web browser executing on a client device for display with a plurality of search results for the at least one query.

4. The system of claim 3 further comprising the web browser executing on the client device, operably coupled to the advertisement serving engine, that displays the list of the at least one advertisement for the at least one query with the plurality of search results for the at least one query.

5. A computer-readable storage medium having computer-executable components comprising the system of claim 1.

6. A computer-implemented method for click prediction of online advertising, comprising:
inputting at least one word feature of a search query into a click prediction model to obtain a plurality of click probabilities for a plurality of pairs of the search query and an advertisement;
obtaining the plurality of click probabilities for the plurality of pairs of the search query and the advertisement;
determining a list of advertisements ranked by an expected value representing a product of a bid and one of the plurality of click probabilities for the plurality of pairs of the search query and the advertisement;
serving the list of advertisements ranked by the expected value for display with results of the search query; and
pricing the list of advertisements in an online search keyword auction.

7. The method of claim 6 further comprising allocating a plurality of web page placements for each advertisement in the list of advertisements ranked by the expected value for display with results of the search query.

8. The method of claim 6 further comprising:
receiving the search query; and
extracting the at least one word feature of the search query.

9. The method of claim 6 wherein serving the list of advertisements ranked by the expected value for display with results of the search query comprises serving the list of advertisements ranked by the expected value to a web browser executing on a client device.

10. The method of claim 6 further comprising generating the click prediction model from a plurality of click feedback features and from a plurality of word pair features of the search query and the plurality of advertisements.

11. The method of claim 10 wherein generating the click prediction model from the plurality of click feedback features and from the plurality of word pair features of the search query and the plurality of advertisements comprises generating a maximum entropy click prediction model from the plurality of click feedback features and from the plurality of word pair features of the search query and the plurality of advertisements.

12. The method of claim 11 further comprising receiving the plurality of click feedback features and the plurality of word pair features of the search query and the plurality of advertisements.

13. The method of claim 12 further comprising receiving a plurality of query term absence features for the search query and the plurality of word pair features of the search query and the plurality of advertisements.

14. The method of claim 11 further comprising estimating a weight for each of the plurality of word pair features by finding a maximum-a-posterior probability for a likelihood of a click probability of the search query and the plurality of advertisements.

15. The method of claim 11 wherein the plurality of word pair features of the search query and the plurality of advertisements comprise at least one word pair feature that is a syntactic match of a word of a query and a word of an advertisement.

16. The method of claim 11 wherein the plurality of word pair features of the search query and the plurality of advertisements comprise at least one word pair feature of a word in the query that is different from a word of an advertisement.

17. A computer-readable storage medium having computer-executable instructions for performing the method of claim 6.

18. A computer system for click prediction of online advertising, comprising:
means for receiving a plurality of click feedback features and a plurality of word pair features of a search query and a plurality of advertisements;
means for generating, from the plurality of click feedback features and from the plurality of word pair features of the search query and the plurality of advertisements, a click prediction model that predicts a click probability for each of a plurality of pairs of the search query and an advertisement of the plurality of advertisements; and
means for outputting the click prediction model that predicts the click probability for each of the plurality of pairs of the search query and the advertisement of the plurality of advertisements.

19. The computer system of claim 18 further comprising:
means for receiving the search query;
means for inputting at least one word feature of the search query into the click prediction model to obtain a plurality of click probabilities for the plurality of pairs of the search query and the advertisement of the plurality of advertisements;
means for determining a list of advertisements ranked by an expected value representing a product of a bid and one of the plurality of click probabilities for the plurality of pairs of the search query and the advertisement of the plurality of advertisements; and
means for serving the list of advertisements ranked by the expected value for display with results of the search query.

20. The computer system of claim 19 further comprising means for displaying the list of advertisements ranked by the expected value with results of the search query.
